(19) United States
(12) Patent Application Publication
(10) Pub. No.: US 2024/0238879 A1
(43) Pub. Date: Jul. 18, 2024

(54) APPARATUS COMPRISING A ROTARY TOOL, AND METHOD FOR ATTACHING AND DETACHING A CUTTING INSERT ON SUCH AN APPARATUS

(71) Applicant: Kennametal Inc., Latrobe, PA (US)

(72) Inventors: Bernhard Eckl, Fuerth (DE); Jürgen Schwägerl, Vohenstrauss (DE)

(21) Appl. No.: 18/411,950

(22) Filed: Jan. 12, 2024

(30) Foreign Application Priority Data
Jan. 16, 2023 (DE) 102023200289.2

(51) Int. Cl. B23B 51/00

(52) U.S. Cl. CPC B23B 51/0004

(57) ABSTRACT

An apparatus is specified that comprises a rotary tool, wherein the rotary tool extends along a longitudinal axis and in an axial direction, wherein the rotary tool comprises a body, a cutting insert and a clamping rod, wherein the body has a shank on the rear-facing end, for clamping into a bracket, wherein the clamping rod extends through the body in the axial direction, wherein the clamping rod is adapted on the front-facing end to attach the cutting insert, wherein the clamping rod extends rearward towards the shank and can be actuated by means of a tool to attach the cutting insert to, or to detach the latter from, the body, wherein the clamping rod comprises an access hole arranged such that the clamping rod can be actuated while the rotary tool is clamped in the bracket. Further, a method for attaching or detaching a cutting insert on such an apparatus is specified.

### RELATED APPLICATION DATA

This application claims priority under 35 U.S.C. § 119 to German Patent Application No. 102023200289.2, which was filed on Jan. 16, 2023 and is incorporated by reference herein in its entirety.

### FIELD

The invention relates to an apparatus comprising a rotary tool and to a method for changing a cutting insert on such an apparatus. The apparatus is for example identical to the rotary tool or is a combination of a bracket and the rotary tool, which is clamped in the bracket. An example of a rotary tool is a drill.

### BACKGROUND

The simplest possible handling is desirable, especially on a rotary tool with a modular design. A modular rotary tool has a body and a separate cutting insert that is releasably attachable to the body. Attaching and detaching and generally changing of the cutting insert is accordingly elaborate and is performed manually, for example by means of a separate tool, e.g., a screwdriver.

### Problem of the Invention

In light of this, it is an object of the invention to simplify attaching and detaching a cutting insert of a rotary tool. In particular, attaching or detaching is to be possible without having to remove the body from the bracket. Furthermore, attaching or detaching is in particular intended to be automatable such that a completely automatic change of the cutting insert is possible. In addition, the rotary tool is to be as stable as possible on the front-facing end, i.e., in the area of the cutting insert.

### SUMMARY

### Solution of the Problem

The object is achieved according to the invention by an apparatus having the features according to claim 1 and by a method having the features according to claim 11. Advantageous configurations, further developments, and variants are the subject matter of the subclaims. The statements made in connection with the apparatus apply analogously to the method and vice versa.

The apparatus comprises a rotary tool, preferably a drill, a milling tool, or a friction tool. The rotary tool extends along a longitudinal axis and in an axial direction. The longitudinal axis extends in axial direction. In operation, the rotary tool rotates about the longitudinal axis to machine a part. The rotary tool has a body and a cutting insert and is thus modular. The cutting insert comprises at least one cutting edge for machining a part when in operation. The cutting insert can be inserted in the front-facing end of the body, i.e., is inserted into the body in an installed state. Preferably, the cutting insert is clamped between two front-facing arms of the body and thereby attached to the body. The cutting insert is, for example, a cutting plate.

The body has a shank on the rear-facing end for clamping into a bracket. The bracket is in particular a part of a machine tool. For example, the bracket is a chuck, e.g., a hydraulic expansion chuck. Suitably, the bracket comprises a collet with which the rotary tool is clamped. The rotary tool has in particular one or more flutes, which extend along the body up to the shank. The shank represents a rear-facing end of the rotary tool. Accordingly, the shank begins in particular where the flutes end and is free of chip grooves. The shank forms a rear-facing end of the body. The shank is adjoined by a working section, which accordingly forms a front-facing end of the body. The body is thus divided into a shank and a working section, but these are in particular manufactured integrally (monolithically). The shank is preferably purely cylindrical or strictly conical in shape and preferably also does not have any chip-forming or chip-evacuating elements. On the other hand, any flutes and any optional cutting edges (e.g., secondary cutting edges, in addition to cutting edges of the cutting insert) are part of the working section. The shank is in particular offset from the working section in the radial direction by a circumferential chamfer or step. The rotary tool, specifically its body, in particular has a diameter larger on the shank than on the working section.

The rotary tool further includes a clamping rod. The clamping rod extends through the body in the axial direction and preferably along the longitudinal axis, i.e., centrally or in the center of the body. In a suitable embodiment, the clamping rod extends through a media channel of the rotary tool and in particular has a smaller diameter than the media channel. The media channel supplies a working medium (e.g., a coolant and/or lubricant) to the cutting insert. The working medium is in particular introduced through a rear-facing opening of the body and exits in particular on the front-facing end through one or more exit openings.

The clamping rod is formed on the front-facing end to attach the cutting insert. For this purpose, the clamping rod has a suitable embodiment and comprises a front-facing end adapted as an outer or inner thread. The cutting insert accordingly has a matching inner or outer thread and is then fastened by threading it onto the clamping rod. In another suitable embodiment, a bayonet lock is formed with two coupling elements, one of which is formed on the cutting insert and the other on the front-facing end of the clamping rod. The cutting insert is assembled by inserting it into the front-facing end of the body and positioning it onto the clamping rod; the clamping rod is then rotated such that the cutting insert is pulled into the body and attached as a result. The clamping rod is detached by rotating it in reverse direction. However, instead of such a threaded connection, other connections are also suitable, e.g., a plug connection, and in particular those connections wherein the cutting insert is attached or detached by a strictly axial displacement (i.e., in the axial direction) of the clamping rod.

In order to now be able to change the cutting insert (i.e., detach the cutting insert and subsequently attach another cutting insert) while the rotary tool is clamped in the bracket, it is principally possible to drive the clamping rod on the front-facing end, e.g., by a lateral screw in the body, which extends accordingly in the radial direction and is generally arranged on the front-facing end. However, a hole is thus formed in the body in the vicinity of the cutting insert, which adversely affects the stability of the rotary tool and reduces its stiffness. Since one or more flutes are typically also formed in the body, the latter is already structurally weakened. In addition, chips can get stuck in the area of the screw or the associated hole and can interfere with the operation of the apparatus. A lateral screw also creates disadvantageous lateral forces in the rotary tool.

In the present case, the clamping rod therefore extends rearward towards the shank and can be actuated by means of a tool to attach the cutting insert to, or detach the latter from, the body. “Attaching or detaching” in this case means that both, attaching and detaching, is possible, depending on whether the cutting insert is to be inserted or removed. The clamping rod is operated using the tool, either directly (e.g., with a tool mating feature for the tool on the clamping rod) or indirectly (e.g., with a further element that has a tool mating feature for the tool and is connected appropriately to the clamping rod). The tool is, for example, a screwdriver.

Compared to the remaining rotary tool, the shank is comparatively solid and in any case significantly more stable and stiffer and also less stressed than the front-facing part (especially a tip) of the rotary tool. This applies similarly for a rear-facing end of the working section, which immediately adjoins the shank, because any flutes already taper off at this end and are therefore less deep. This rear-facing end has a length preferably corresponding to at most two times the diameter of the rotary tool. In a suitable embodiment, the length is at most 20% of a total length of the working section, but the length can be more than 20% of the total length for a rotary tool with a very short working section. Similarly to the shank, the rear-facing end is also suitably offset in relation to the remaining working section by a chamfer or step (not necessarily circumferentially due to the fluting).

The clamping rod preferably extends to the rear-facing end of the shank (i.e., in particular, “ends in the shank”) and can then be actuated there as well, i.e., in particular within the shank, using the tool. Alternatively, the clamping rod only extends into the rear-facing end of the working section, preferably ends there, and can also be actuated there using the tool. The clamping rod preferably extends to a flute-free sub-region of the working section that lies between the shank and the flutes when viewed in the axial direction, or to a tapered region of the working section on which the flutes taper off. However, an embodiment wherein the clamping rod extends completely through the shank is also suitable.

Accordingly, the access required for actuation is advantageously routed from the front-facing end to the rear-facing end in the present case. This achieves high stability and high stiffness on the front-facing end. However, such rear-facing end actuation typically requires the rotary tool to be removed from the bracket to change the cutting insert. Therefore, the apparatus additionally has an access hole arranged such that the clamping rod can be actuated while the rotary tool is clamped in the bracket. In other words, the clamping rod can be actuated through the access hole, and the access hole is accessible when clamped. Thus, an operation of the clamping rod and thus a change of the cutting insert is advantageously possible while the rotary tool is clamped into the bracket. There are various suitable embodiments for arranging the access hole and the manner in which the clamping rod is actuated by means of the tool, which are explained in further detail below.

The apparatus is identical to the rotary tool in a first preferred embodiment. In a second preferred embodiment, the apparatus is a combination of the rotary tool and the bracket, e.g., the apparatus is a machine tool, with a bracket into which the rotary tool is clamped.

“Front-facing end” in particular means “on/in/along a front half of the body”, especially in the area of the cutting insert, and “rear-facing end” analogously means “on/in/along a rear half of the body”, especially in the area of the shank.

The clamping rod is expediently supported on the body and is in particular fixed in the axial direction. In a first suitable embodiment, a deadstop for the clamping rod is formed in the body in axial direction. In a second suitable embodiment, the clamping rod and the body are joined by means of a threaded connection, wherein the clamping rod is likewise to some extent fixed. For example, the clamping rod has a right-left thread, with a right-threaded section, for attaching the cutting insert as already described, and with a left-threaded section, for attachment in the body, which has a correspondingly matching inner thread (the left and right-threaded part can also be switched). In any case, it is ensured that the clamping rod is not arbitrarily movable in axial direction relative to the body, but is instead fixed.

The rotary tool is adapted in a suitable embodiment such that the clamping rod is rotated when actuated, thus attaching or detaching the cutting insert. By rotating the clamping rod in one direction or the other, the cutting insert is then attached or detached accordingly, e.g., threaded, as already described above. The clamping rod can in particular be rotated about the longitudinal axis. The clamping rod is rotated by driving the latter indirectly or directly with the tool. However, a strictly axial actuation is alternatively possible and suitable. In this case, the clamping rod is actuated by an axial displacement, i.e., a displacement in the axial direction, thus attaching or detaching the cutting insert.

Preferably, the apparatus comprises a transverse pin that forms a transmission with the clamping rod, wherein the transmission is adapted such that the clamping rod is actuated by actuating the transverse pin using the tool, thus attaching or detaching the cutting insert. The access hole is formed in the shank or in the rear-facing end of the working section and the transverse pin is seated in the access hole. Accordingly, to change the cutting insert, the transverse pin is actuated with the tool and the transverse pin then drives the clamping rod, thereby attaching or detaching the cutting insert depending on the direction. The transverse pin is accessible from outside of the rotary tool. The transverse pin is in particular cylindrical. At an end that points outward from the access hole, the transverse pin expediently has a tool mating feature for the tool.

It is also principally conceivable that a transverse pin is not seated in the access hole and the tool is inserted through the access hole to actuate the clamping rod directly.

In an advantageous embodiment, the clamping rod has a thickened region on the rear-facing end, with an inclined and in particular annular attack surface, i.e., the attack surface describes an angle of more than 90° with the longitudinal axis. The thickened region preferably forms a rear-facing end of the clamping rod. The end-facing side of the transverse pin preferably cooperates with the attack surface such that the clamping rod is driven when the transverse pin is actuated. For this purpose, the transverse pin and the attack surface are in particular provided with suitable geared surfaces, e.g., in the manner of a bevel gear.

The access hole is arranged in a suitable embodiment at an angle of at most 75° relative to the longitudinal axis. The front-facing angle is meant in this particular case. The angle is in particular greater than 0°.

Preferably, the transverse pin extends along a pin axis and can be actuated either by axial movement towards the pin axis or by a rotation about the pin axis. Thus, in principle, two different actuations are advantageous. Because the transverse pin is seated in the access hole, the pin axis also extends along the access hole and thus at a corresponding angle to the longitudinal axis.

As an alternative to the access hole in the shank or the rear-facing end of the working section of the rotary tool, the apparatus comprises a bracket in a suitable embodiment, wherein the rotary tool can be clamped such that the shank—in a clamped state—is clamped in the bracket, and the bracket now comprises the access hole by which the clamping rod can be operated, in particular from outside, and through, the bracket. For example, the access hole is integrated into a wall of the bracket.

Preferably, the access hole extends in a radial direction perpendicular to the axial direction, and the bracket includes a transmission having a transverse pin seated in the access hole and an axial pin connected to the clamping rod. In particular, the transmission is adapted such that the axial pin and consequently ultimately also the clamping rod are driven when the transverse pin is actuated by means of the tool, thus attaching and detaching the cutting insert. The axial pin and the clamping rod are either manufactured integrally (monolithically) or as multiple parts, i.e., as two separate components. In the latter case, the axial pin and the clamping rod are suitably connected to each other, e.g., using corresponding insertion or mating contours.

The transverse pin preferably extends in the radial direction and expediently not directly towards, but instead laterally past, the longitudinal axis. The transmission is then for example realized as a worm gear, wherein the transverse pin has a worm thread and the axial pin has correspondingly suitable gears to cooperate with the transverse pin. However, other types of transmissions are generally also possible and suitable, in particular also a bevel gear as described above, wherein the transverse pin then expediently projects towards the axial pin and the longitudinal axis, suitably at an angle of less than 90° in relation to the longitudinal axis.

Generally, the transverse pin and the clamping rod (and optionally additionally with the axial pin) together form a mechanism, in particular a clamping mechanism, for attaching and detaching the cutting insert. This mechanism is completely integrated into the rotary tool in the embodiment described above with the transverse pin in the rear-facing end of the working section or in the shank. However, the mechanism can also be suitably partially incorporated into the bracket, thus forming the mechanism by combining the rotary tool and bracket. This is the case for the alternative also described above. The clamping rod is then still part of the rotary tool, but is now actuated using the access hole and the transverse pin (and optionally the axial pin) of the bracket.

The discussion regarding the access hole, the transmission and the transverse pin in connection with the embodiment with the access hole in the shank also apply likewise to the embodiment with the access hole in the bracket and vice versa.

Expediently, the clamping rod projects rearward out of the shank and in the axial direction. In particular, the clamping rod is as a result longer than the body. In the clamped state, the clamping rod projects into the bracket and can then be actuated from there, either directly with the tool or indirectly using the transverse pin and optionally the additional axial pin.

As an alternative to an access hole of the bracket in the radial direction, an embodiment is also advantageous wherein the access hole extends along the longitudinal axis. Actuation by means of the tool is then carried out along the longitudinal axis; for this purpose, the clamping rod has a corresponding tool mating feature at the rear-facing end. This embodiment is particularly simple because no additional mechanism and no transmission are needed to actuate the clamping rod, the latter is instead actuated directly through the bracket with the tool.

The method is intended for fastening or detaching, specifically for changing, a cutting insert in an apparatus as described above. The cutting insert is detached or attached, specifically changed, while the rotary tool is clamped in the bracket.

The above-described embodiments of the apparatus are particularly suitable for fully-automated attaching or detaching of the cutting insert, preferably by means of a robot. No manual intervention is required. Accordingly, the described method is also preferably carried out entirely automatically, in particular by a robot. This also enables automatic indexing of cutting inserts for multiple applications. This is expediently combined with pre-setter functionality.

### DESCRIPTION OF THE DRAWINGS

Exemplary embodiments of the invention are explained in more detail below with reference to a drawing. The drawing schematically shows in

FIG. 1 an exploded view of a bracket and a rotary tool,

FIG. 2a the bracket and rotary tool of FIG. 1 in a side view,

FIG. 2b a sectional view based on FIG. 2a,

FIG. 3a the rotary tool of FIG. 1 in a side view,

FIG. 3b a sectional view based on FIG. 3a,

FIG. 4 a variant of the bracket and the rotary tool of FIG. 1,

FIG. 5 an exploded view of the bracket and rotary tool of FIG. 4,

FIG. 6a the bracket and rotary tool of FIG. 4 in a side view,

FIG. 6b a sectional view based on FIG. 6a,

FIG. 7a the bracket and rotary tool of FIG. 4 in another side view,

FIG. 7b a sectional view based on FIG. 7a,

FIG. 8 a further variant of the bracket and the rotary tool of FIG. 1.

### DETAILED DESCRIPTION

### Description of the Exemplary Embodiment

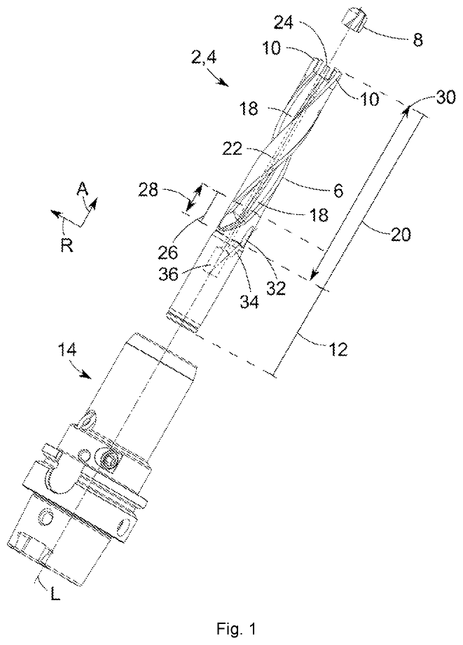

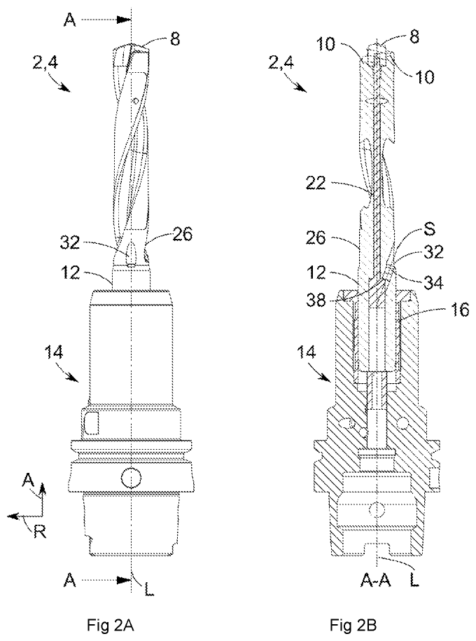

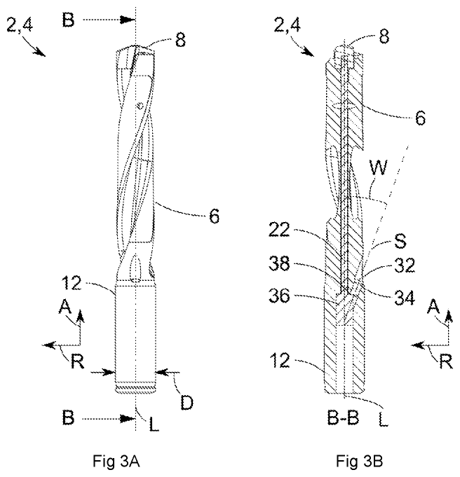

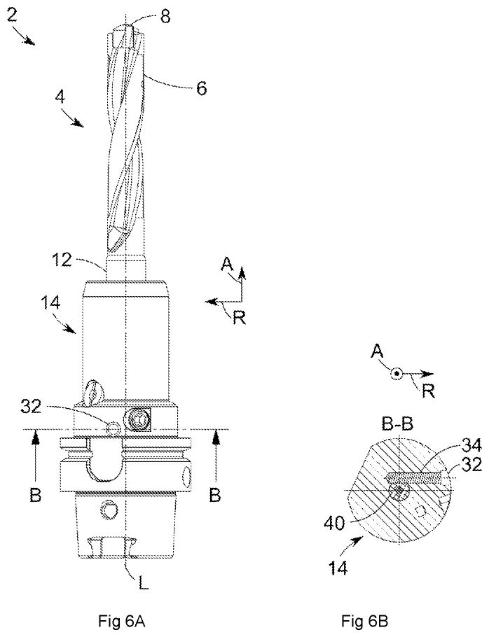

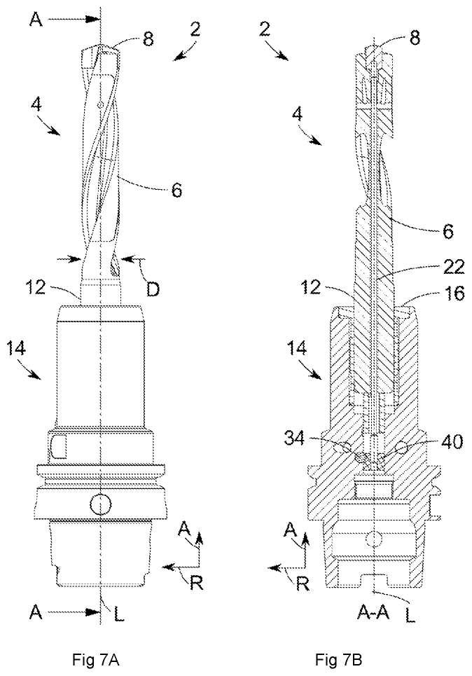

Various exemplary embodiments for an apparatus 2 are shown in FIGS. 1 to 8. The apparatus 2 comprises a rotary tool 4—here a drill in each case. The rotary tool 4 extends along a longitudinal axis L and in an axial direction A. The longitudinal axis L extends in the axial direction A. In operation, the rotary tool 4 rotates about the longitudinal axis L for machining a part. The rotary tool 4 has a body 6 and a cutting insert 8 and is thus modular. The cutting insert 8 comprises at least one not explicitly labeled cutting edge for machining a part when in operation. The cutting insert 8 can be inserted in the front-facing end of the body 6, i.e., is inserted into the body 6 in a mounted state, e.g., as shown in FIG. 2a, 4 or 6a. The cutting insert 8 is clamped between two front-facing arms 10 of the body 4, and is thus attached to the latter. The cutting insert 8 is a cutting plate in the exemplary embodiments shown.

The body 6 has a shank 12 on the rear-facing end for clamping into a bracket 14. The bracket 14 for example comprises a collet 16 with which the rotary tool 4 is clamped. In the exemplary embodiments shown here, the rotary tool 4 also comprises a plurality of flutes 18 extending along the body 6 up to the shank 12. The shank 12 represents a rear-facing end of the body 6 and also of the rotary tool 4 as a whole. In the present case, the shank 12 begins where the flutes 18 end and is free of flutes. A working section 20 adjoins the shank 12, which respectively forms a front-facing end of the body 6. The body 6 is thus divided into a shank 12 and a working section 20, but these are in the present case manufactured integrally (monolithically). In the present case, the shank 12 is strictly cylindrical in shape and does not have any chip-forming or chip-evacuating elements. On the other hand, any flutes 18 and any optional cutting edges (e.g., secondary cutting edges, in addition to cutting edges of the cutting insert 8) are part of the working section 20. In the present case, the shank 12 is offset from the working section 20 by a circumferential chamfer or step in the radial direction R. The rotary tool 4 shown here also has a diameter D that is larger on the shank 12 than on the working section 20.

The rotary tool 4 further comprises a clamping rod 22. The clamping rod 22 extends through the body 6 in the axial direction A and along the longitudinal axis L, i.e., centrally or in the center of the body 6. In the exemplary embodiments shown here, the clamping rod 22 extends through a not explicitly labeled media channel of the rotary tool 4 and has a smaller diameter than said media channel. The media channel supplies a working medium (e.g., a coolant and/or lubricant) to the cutting insert 8. The working medium is in the present case introduced through a rear-facing opening of the body 6 and exits on the front-facing end through several exit openings.

The clamping rod 22 is formed on the front-facing end to attach the cutting insert 8. For this purpose, the clamping rod 22 has in the embodiments shown here a front-facing end 24 adapted as an outer thread. The cutting insert 8 accordingly has a matching inner thread and is then attached by threading it onto the clamping rod 22. The cutting insert 8 is assembled by inserting it into the front-facing end of the body 6 and positioning it onto the clamping rod 22; the clamping rod 22 is then rotated such that the cutting insert 8 is pulled into the body 6 and attached as a result. The clamping rod 22 is detached by rotating it in reverse direction. However, other connections not explicitly shown are also suitable instead of such a threaded connection.

In the present case, the clamping rod 22 extends rearward at least up to the shank 12 and can be actuated there by means of a not explicitly shown tool in order to attach or detach the cutting insert 12 from the body 6. “Attaching or detaching” in this case means that both, attaching and detaching, is possible, depending on whether the cutting insert 8 is to be inserted or removed. The clamping rod 22 is operated using the tool, either directly (e.g., with a tool mating feature for the tool on the clamping rod 22) or indirectly (e.g., with a further element that has a tool mating feature for the tool and is connected appropriately to the clamping rod 22). The tool is, for example, a screwdriver.

Compared to the remaining rotary tool 4, the shank 12 is comparatively solid and in any case significantly more stable and stiffer and also less stressed than the front-facing part (specifically a tip) of the rotary tool 4. The same applies for a rear-facing end 26 of the working section 20, which immediately adjoins the shank 12, since any flutes 18 already taper off at this end 26 and are therefore less deep. This rear-facing end 26 has a length 28 in particular corresponding to at most two times the diameter D. Similarly to the shank 12, the rear-facing end 26 is also offset in relation to the remaining working section 20 by a chamfer or step (not necessarily circumferentially due to the fluting 18).

In an alternative not shown, the clamping rod 22 does not project into, but extends just short of, the shank 12, i.e., into the rear-facing end 26, and already ends there.

In the present case, the access necessary for actuating the clamping rod 22 is arranged on the rear-facing end. This achieves high stability and high stiffness on the front-facing end. However, such rear actuation typically requires the rotary tool 4 to be removed from the bracket 14 to change the cutting insert 8. Therefore, the apparatus 2 additionally has an access hole 32 arranged such that the clamping rod 22 can be actuated while the rotary tool 4 is clamped in the bracket 14. In other words, the clamping rod 22 can be actuated through the access hole 32, and said access hole 32 is accessible in the clamped state. Thus, an operation of the clamping rod 22 and a change of the cutting insert 8 is possible while the rotary tool 4 is clamped in the bracket 14.

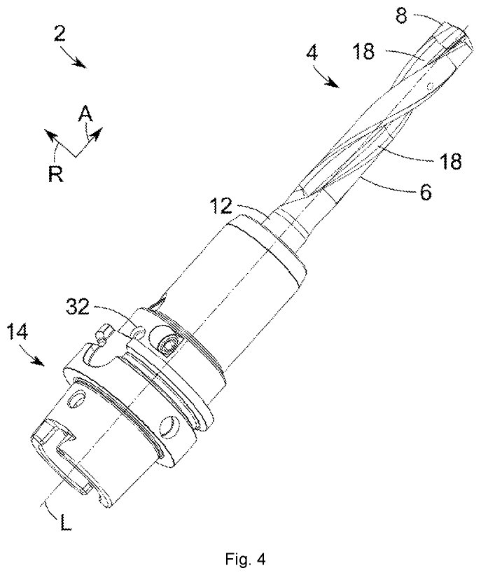

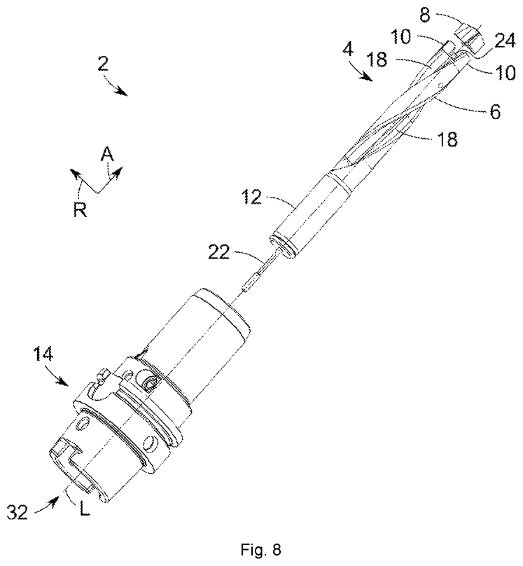

Various embodiments are possible for arranging the access hole 32 and the manner in which the clamping rod 22 is operated using the tool, three of which are shown in FIGS. 1 to 8. FIGS. 1 to 3b show a first embodiment, FIGS. 4 to 7b show a second embodiment, and FIG. 8 shows a third embodiment. In FIGS. 1 to 3b, the apparatus 2 is identical to the rotary tool 4; the bracket 14 is not necessarily a part of the apparatus 2. In FIGS. 4 to 8, on the other hand, the apparatus 2 is a combination of the rotary tool 4 and the bracket 14.

“Front-facing” in this case means “on/in/along a front half of the body 6”, especially in the area of the cutting insert 8, and “rear-facing” analogously means “on/in/along a rear half of the body 6”, especially in the area of the shank 12.

In the present case, the clamping rod 22 is positioned on the body 6 and fixed in the axial direction A. This can be seen particularly clearly in the sectional views in FIGS. 2b,3b, and 7b. For example, a deadstop for the clamping rod 22 in the axial direction A is formed in the body 6, or the clamping rod 22 and the body 6 are joined by means of a threaded connection, e.g., the clamping rod 22 has a right-left thread.

The rotary tool 4 is adapted in the design examples shown here such that the clamping rod 22 is actuated by rotating the latter, thus attaching or detaching the cutting insert 8. By rotating the clamping rod 22 in one direction or the other, the cutting insert 8 is then attached or detached accordingly, e.g., threaded. The clamping rod 22 can then be rotated about the longitudinal axis. The clamping rod 22 is rotated by driving the latter indirectly or directly with the tool. However, in a not explicitly shown variant, a strictly axial actuation is instead possible, wherein the clamping rod 22 is actuated by an axial displacement, i.e., a displacement in the axial direction A, thus attaching or detaching the cutting insert 8.

In the embodiment shown in FIGS. 1 to 3b, the apparatus 2 comprises a transverse pin 34 that forms a transmission with the clamping rod 22, wherein the transmission is adapted such that the clamping rod 22 is actuated by actuating the transverse pin 34 using the tool, thus attaching or detaching the cutting insert 8. In the exemplary embodiment shown, the access hole 32 is formed in the rear-facing end 26 of the working section 20; in a not shown embodiment, the access hole 32 is formed in the shank 12. The transverse pin 34 is seated in the access hole 32. Accordingly, to change the cutting insert 8, the transverse pin 34 is actuated with the tool and the transverse pin 34 then drives the clamping rod 22, thereby attaching or detaching the cutting insert 8 depending on the direction. The transverse pin 34 is accessible from outside of the rotary tool 4. In the present case, the transverse pin 34 is cylindrical in shape and has a tool mating feature for the tool at the end facing outward from the access hole 32.

An embodiment is also principally conceivable wherein a transverse pin 34 is not seated in the access hole 32 and the tool is inserted through the access hole 32 to actuate the clamping rod 22 directly.

In the exemplary embodiment of FIGS. 1 to 3b, the clamping rod 22 has a thickened region 36 on the rear-facing end, with an inclined and also annular attack surface 38 therein. The thickened region 36 in this case also forms a rear-facing end of the clamping rod 22. The end face of the transverse pin 34 cooperates with the attack surface 38 such that the clamping rod 22 is driven when the transverse pin 34 is actuated. For this purpose, the transverse pin 34 and the attack surface 38 are for example provided with suitable gear surfaces.

In the embodiment shown here, the access hole 32 is arranged at an angle W of at most 75° relative to the longitudinal axis L. The front-facing angle W is meant in this particular case.

The transverse pin 34 extends along a pin axis S and can be actuated either by axial movement towards the pin axis S or by a rotation about the pin axis S. Because the transverse pin 34 is seated in the access hole 32, the pin axis S also extends along the access hole 32 and thus at a corresponding angle W to the longitudinal axis L.

As an alternative to the access hole 32 in the shank 12 or the rear-facing end 26 of the working section 20 of the rotary tool 4, the apparatus 2 comprises a bracket 14 in the embodiments of FIGS. 4 to 8, into which the rotary tool 4 can be clamped such that the shank 12—in the clamped state—is clamped in the bracket 14 and now has the access hole 32, by which the clamping rod 22 can be operated from outside, and through, the bracket 14. In FIGS. 4 to 7b, the access hole 32 is incorporated into a wall of the bracket 14; in FIG. 8, the access hole 32 is incorporated into the rear-facing end of bracket 14.

In the exemplary embodiment according to FIGS. 4 to 7b, the access hole 32 extends in radial direction R perpendicular to the axial direction A, and the bracket 14 comprises a transmission having a transverse pin 34 seated in the access hole 32 and an axial pin 40 connected to the clamping rod 22. In the present case, the transmission is adapted such that the axial pin 40 and consequently ultimately also the clamping rod 22 are driven when the transverse pin 34 is actuated by means of the tool, thus attaching and detaching the cutting insert 8. The axial pin 40 and the clamping rod 22 are either manufactured integrally (monolithically) or as multiple parts, i.e., as two separate components. In the latter case, the axial pin 40 and the clamping rod 22 are suitably connected to each other, e.g., using corresponding insertion or mating contours.

In the present case, the transverse pin 34 extends in the radial direction R and not directly towards, but instead laterally past, the longitudinal axis L. The transmission is for example realized as a worm gear, wherein the transverse pin 34 has a worm thread and the axial pin 40 has correspondingly suitable gears to cooperate with the transverse pin 34. However, other types of transmissions are also possible.

Generally, the transverse pin 34 and the clamping rod 22 (and optionally additionally with the axial pin 40) together form a mechanism for attaching and detaching the cutting insert 8. In the embodiment described above in connection with FIGS. 1 to 3b with the transverse pin 34 in the rear-facing end 26 of the working section 20 or in the shank 12, this mechanism is completely integrated into the rotary tool 4. In the embodiments of FIGS. 4 to 8, on the other hand, the mechanism is partially integrated into the bracket 14 such that the mechanism is formed by the combination of the rotary tool 4 and bracket 14. The clamping rod 22 is then still part of the rotary tool 4, but is now actuated using the access hole 32 and the transverse pin 34 (and optionally the axial pin 40) of the bracket 14.

The discussion regarding the access hole 32, the transmission and the transverse pin 34 in connection with the embodiments of FIGS. 1 to 3b also applies likewise to the embodiments of FIGS. 4 to 8 and vice versa.

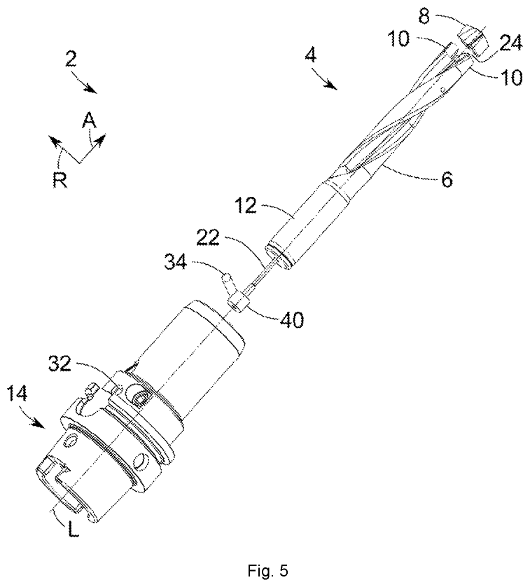

In the exemplary embodiments according to FIGS. 4 to 8, the clamping rod 22 projects rearward and out of the shank 12 in the axial direction A. This can be seen particularly clearly in FIGS. 5 and 8. The clamping rod 22 is as a result longer than the body 6. In the clamped state, the clamping rod 22 projects into the bracket 14 and can then be actuated from there, either directly with the tool or indirectly using the transverse pin 34 and optionally the additional axial pin 40.

As an alternative to an access hole 32 of the bracket 14 in the radial direction R, as shown in FIGS. 4 to 7b, an embodiment as shown in FIG. 8 is also possible, wherein the access hole 32 extends along the longitudinal axis L. Actuation by means of the tool is then carried out along the longitudinal axis L; for this purpose, the clamping rod 22 has a corresponding tool mating feature at the rear-facing end.

In a method for attaching or detaching the cutting insert 8 in an apparatus 2 as described above, the cutting insert 8 is detached or attached, specifically changed, while the rotary tool 4 is clamped in the bracket 14, e.g., completely automatically by means of a not explicitly shown robot. No manual intervention is required. This also enables automatic indexing of cutting inserts 8 for multiple applications. In a not explicitly shown embodiment, this is combined with pre-setter functionality.

1. An apparatus comprising a rotary tool, wherein:
the rotary tool extends along a longitudinal axis and in an axial direction;
the rotary tool comprises a body, a cutting insert and a clamping rod;
the body comprises a shank on the rear-facing end for clamping into a bracket;
the clamping rod extends through the body in the axial direction;
the clamping rod is formed on the front-facing end to attach the cutting insert;
the clamping rod extends rearward towards the shank and can be actuated by means of a tool for attaching the cutting insert to, or detaching the latter from, the body; and
an access hole is arranged such that the clamping rod can be actuated while the rotary tool is clamped in the bracket.

2. The apparatus according to claim 1, wherein:
the rotary tool is adapted such that when the clamping rod is actuated, the latter is rotated, thus attaching or detaching the cutting insert.

3. The apparatus according to claim 1, wherein:
the apparatus comprises a transverse pin that forms a transmission with the clamping rod, wherein the transmission is adapted such that the clamping rod is actuated by actuating the transverse pin by means of the tool, thus attaching or detaching the cutting insert; and
the access hole is formed in the shank or in a rear-facing end of a working section of the rotary tool, and the transverse pin is seated in the access hole.

4. The apparatus according to claim 3, wherein:
the clamping rod has a thickened region on the rear-facing end, with an inclined attack surface; and
the transverse pin cooperates with the attack surface such that the clamping rod is driven when the transverse pin is actuated.

5. The apparatus according to claim 3, wherein
the access hole is arranged at an angle of at most 60° relative to the longitudinal axis.

6. The apparatus according to claim 3, wherein
the transverse pin extends along a pin axis and can be actuated either by an axial movement towards the pin axis=or by a rotation about the pin axis.

7. The apparatus according to claim 1, wherein:
the apparatus comprises a bracket into which the rotary tool can be clamped such that the shank, when in a clamped state, is clamped in the bracket; and
the bracket comprises the access hole by which the clamp rod can be operated.

8. The apparatus according to claim 7, wherein:
the access hole extends in a radial direction perpendicular to the axial direction;
the bracket comprises a transmission having a transverse pin seated in the access hole and an axial pin connected to the clamping rod; and
the transmission is adapted such that the axial pin and thus also the clamping rod are driven by actuating the transverse pin by means of the tool, thus attaching or detaching the cutting insert.

9. The apparatus according to claim 7, wherein
the clamping rod projects rearward and in the axial direction from the shank.

10. The apparatus according to claim 7, wherein
the access hole extends along the longitudinal axis.

11. A method of attaching or detaching a cutting insert on an apparatus according to claim 1, wherein
the cutting insert is detached or attached while the rotary tool is clamped in the bracket.

12. The apparatus according to claim 2, wherein:
the apparatus comprises a transverse pin that forms a transmission with the clamping rod, wherein the transmission is adapted such that the clamping rod is actuated by actuating the transverse pin by means of the tool, thus attaching or detaching the cutting insert; and
the access hole is formed in the shank or in a rear-facing end of a working section of the rotary tool, and the transverse pin is seated in the access hole.

13. The apparatus according to claim 12, wherein:
the clamping rod has a thickened region on the rear-facing end, with an inclined attack surface; and
the transverse pin cooperates with the attack surface such that the clamping rod is driven when the transverse pin is actuated.

14. The apparatus according to claim 12, wherein
the access hole is arranged at an angle of at most 60° relative to the longitudinal axis.

15. The apparatus according to claim 13, wherein
the access hole is arranged at an angle of at most 60° relative to the longitudinal axis.

16. The apparatus according to claim 4, wherein
the access hole is arranged at an angle of at most 60° relative to the longitudinal axis.

17. The apparatus according to claim 2, wherein:
the apparatus comprises a bracket into which the rotary tool can be clamped such that the shank, when in a clamped state, is clamped in the bracket; and
the bracket comprises the access hole by which the clamp rod can be operated.

18. The apparatus according to claim 17, wherein:
the access hole extends in a radial direction perpendicular to the axial direction;
the bracket comprises a transmission having a transverse pin seated in the access hole and an axial pin connected to the clamping rod; and
the transmission is adapted such that the axial pin and thus also the clamping rod are driven by actuating the transverse pin by means of the tool, thus attaching or detaching the cutting insert.

19. The apparatus according to claim 17, wherein
the clamping rod projects rearward and in the axial direction from the shank.

20. The apparatus according to claim 8, wherein
the clamping rod projects rearward and in the axial direction from the shank.
